(19) United States
(12) Patent Application Publication
(10) Pub. No.: US 2022/0184891 A1
(43) Pub. Date: Jun. 16, 2022

(54) THREE-DIMENSIONAL PRINTING SYSTEM BUILD CHAMBER

(71) Applicant: Hewlett-Packard Development Company, L.P., Spring, TX (US)

(72) Inventor: Michael A. Novick, San Diego, CA (US)

(73) Assignee: Hewlett-Packard Development Company, L.P., Spring, TX (US)

(21) Appl. No.: 17/414,993

(22) PCT Filed: Jul. 29, 2019
(86) PCT No.: PCT/US2019/043922

§ 371 Date: Jun. 17, 2021

(51) Int. Cl. B29C 64/321; B29C 64/153; B29C 64/245; B29C 64/214; B33Y 10/00; B33Y 30/00

(52) U.S. Cl. CPC B29C 64/321; B29C 64/153; B33Y 30/00; B29C 64/214; B33Y 10/00; B29C 64/245

(57) ABSTRACT

A three-dimensional (3D) printing system may include a build volume having an underlying build platform, a chain link conveyor to deposit build material in a row and a spreader to spread the row over the build platform.

### BACKGROUND

Three-dimensional printing systems, also referred to as additive manufacturing systems, facilitate the generation of three-dimensional objects on a layer-by-layer basis. Such 3D printing techniques generate the layers of an object by forming successive layers of the build material in a build volume and by selectively solidifying portions of each layer.

### BRIEF DESCRIPTION OF THE DRAWINGS

FIG. 1 is a top view schematically illustrating portions of an example 3D printing system build chamber.

FIG. 2 is a flow diagram of an example build chamber layer forming method.

FIG. 3A is a side view schematically illustrating portions of an example build chamber with a lifter at a first height supporting a formed row of build material.

FIG. 3B is a side view schematically illustrate portions of the example build chamber of FIG. 3A with the lifter at a second height supporting the formed row of build material.

FIG. 3C is a side view schematically illustrating portions of the example build chamber of FIG. 3B with a spreader having spread the row of build material off the lifter on an example build platform of an example build volume.

FIG. 4 is a top view schematically illustrating portions of an example build chamber.

FIG. 5A is a sectional view of a portion of the example build chamber of FIG. 4 during inflow of build material into an example chain link conveyor at a first time.

FIG. 5B is a sectional view of the portion of the example build chamber of FIG. 4 taken along line 5B-5B.

FIG. 6A is a sectional view of a portion of the example build chamber of FIG. 4 during inflow of build material into the example chain link conveyor at a second time.

FIG. 6B is a sectional view of the portion of the example build chamber of FIG. 4 taken along line 6B-6B.

FIG. 7A is a sectional view of a portion of the example build chamber of FIG. 4 during the discharge of build material from the example chain link conveyor at a first time.

FIG. 7B is a sectional view of the portion of the example build chamber of FIG. 4 taken along line 7B-7B.

FIG. 8A is a sectional view of a portion of the example build chamber of FIG. 4 during the discharge of build material from the example chain link conveyor at a second time.

FIG. 8B is a sectional view of the portion of the example build chamber of FIG. 4 taken along line 8B-8B.

FIG. 9A is a sectional view of a portion of the example build chamber of FIG. 4 during the discharge of build material from the example chain link conveyor at a third time.

FIG. 9B is a sectional view of the portion of the example build chamber of FIG. 4 taken along line 9B-9B.

FIG. 10A is a sectional view of a portion of the example build chamber of FIG. 4 during the discharge of build material from the example chain link conveyor at a fourth time.

FIG. 10B is a sectional view of the portion of the example build chamber of FIG. 4 taken along line 10B-10B.

FIG. 11 is a side view schematically illustrating portions of an example build chamber.

FIG. 12 is a side view schematically illustrating portions of a 3D printing system having an example build chamber.

FIG. 13 is a sectional view of the example build chamber of FIG. 12 taken along line 13-13.

FIG. 14 is a sectional view of the example build chamber of FIG. 13 take along line 14-14.

FIG. 15 is a top view schematically illustrating portions of example build chamber of an example 3D printing system.

FIG. 16 is a sectional view of the example build chamber of FIG. 15 taken along line 16-16.

FIG. 17 is a side view schematically illustrating portions of an example 3D printing system and an example build chamber during various stages of row formation.

FIG. 18 is an enlarged perspective view of a portion of the example build chamber of FIG. 17 taken along line 18-18.

FIG. 19A is a sectional view illustrating portions of an example 3D printing system and an example build chamber with an example lifting ram in a first position.

FIG. 19B is a sectional view illustrating portions of the example 3D printing system an example build chamber of FIG. 19A with the example lifting ram in a second position.

Throughout the drawings, identical reference numbers designate similar, but not necessarily identical, elements. The figures are not necessarily to scale, and the size of some parts may be exaggerated to more clearly illustrate the example shown. Moreover, the drawings provide examples and/or implementations consistent with the description; however, the description is not limited to the examples and/or implementations provided in the drawings.

### DETAILED DESCRIPTION OF EXAMPLES

Disclosed are example build chambers for three-dimensional printing systems and corresponding build chamber layer forming methods that form the successive layers of build material in the build volume during 3D printing. As compared to many existing 3D printing system build chambers, the disclosed example build chambers may be less complex and more compact, potentially reducing cost. The disclosed build chambers utilize a chain link conveyor to form a line or row of build material, wherein a spreader spreads the line or row of build material over and across a build platform of a build volume to form a layer of build material.

The chain link conveyor concurrently provides two functions: (1) conveying a controlled quantity or dose of build material from a build material supply and (2) spreading the quantity or dose of build material in a row along the top of the build volume. Because the build material is mechanically conveyed rather than being blown, the amount of build material that may become airborne is reduced. Because the chain link conveyor itself forms the row of build material, additional componentry such as vibrators, graders or compactors otherwise used to spread a dose of build material along the edge of build volume may be reduced or eliminated. Reducing or eliminating vibrators, graders and compactors may reduce cost and reduce the overall size of the build chamber. In addition, by reducing or avoiding reliance upon vibrators to spread material, the likelihood of the build material powder separating or segregating based upon varying powder particle sizes and weights is further reduced.

In some implementations, the chain link conveyor forms the row of build material at a height below the build platform, below the top of the build volume and/or below the top of the topmost layer of build material in the build volume, wherein a lifter lifts or raises the row as a row while maintaining the general length of the row to an elevated height for being spread over the build platform. In one implementation, the lifter comprises a ram which vertically raises and linearly translates the row of build material as a row. In another implementation, the lifter comprises a rotatable vein which vertically moves the build material as a row along an arc. Because the row is lifted to the top edge of the build volume, rather than being deposited from above, the overall height of the build chamber may be reduced and valuable real estate above the build volume is conserved for other components of the 3D printing system that selectively solidify portions of the formed layer of build material. In yet other implementations, the lifter may be omitted where the chain link conveyor deposits the row of build material on a surface at a height ready for spreading over the build platform.

In some implementations, the build material supply is located at a height below the build platform. In such an implementation, chain link conveyor may vertically lift and convey build material from the build material supply. In some implementations, the build material supply is located directly beneath the build platform so as to underlie the build platform, conserving space. In yet other implementations, the build material supply may be located at a height above the build platform or above the build volume.

Disclosed are example build chambers and build layer forming methods that may enhance the withdrawal of build material from a build material supply. In many existing build chambers, the build material is withdrawn from the build material supply at a single location or point within the build supply. Such single-point extraction of build material may result in the build material bridging or forming rat holes. Rat holes refers to the funnel-shaped surface of build material extending to and about a single input port, wherein the funnel-shaped surface of the build material inhibits further flow of build material to the input port. Even though the build supply may not be empty, the bridging or rat holes may inhibit further withdrawal of build material from the build material supply. To address such issues, many existing build chambers include additional components to break up the aggregated build material within the build supplies and/or increase the size or height of the build supplies to reliably supply build material during printing.

In contrast to such existing build chambers, the disclosed example build chambers and methods withdraw or extract build material using the chain link conveyor, wherein the chain link conveyor has an elongate opening exposing chain links of the conveyor across a majority of a length of the build material supply. Because build material is withdrawn or extracted along a continuous line provided by the chain link conveyor across a majority, if not all of, the length of the build material supply, the build material is less likely to bridge or form rat holes. In some circumstances, withdrawal of build material along the length of the elongate opening cause any rat holes that form to collapse. As a result, the disclosed example build chambers and methods may more reliably supply build material during 3D printing.

In some implementations, the build chamber may utilize a chain link conveyor that extends along a serpentine path along a floor of the build material supply. The serpentine path of the chain link conveyor facilitates more complete and reliable removal of build material from the supply. In some implementations, the build chamber may utilize multiple different chain-link conveyors on opposite sides of the build material supply, wherein the different chain-link conveyors supply rows of build material to different lifters located on opposite sides of the build volume. In such implementations, the different chain-link conveyors may each extend along individual serpentine paths along the bottom or floor of the build material supply.

In some implementations, the floors of build supply may comprise double-sided ramps to direct build material to the exposed portions of the chain link conveyor or the exposed portions of the multiple chain-link conveyors. In some implementations, the floor of the build material supply may comprise a double-sided ramp between the different chain-link conveyors along the floor of the build supply or may comprise a double-sided ramp along the floor of the build material supply between each consecutive legs of the serpentine path of a chain-link conveyor.

Throughout this disclosure, the example build chambers are described as supplying the build material that is used to form the successive layers of build material in the build volume. Such build material may be in a powdered or granular form. In one example implementation, a suitable build material may be a powdered semi-crystalline thermoplastic material. One suitable material may be PA12 build material commercially known as V1R10A “HP PA12” available from HP Inc.

In yet other implementations, other suitable build materials may be used. Examples of such other suitable build materials include, but are not limited to, powdered metal materials, powdered plastics materials, powdered composite materials, powdered ceramic materials, powdered class materials, powdered resin materials, powdered polymeric materials and the like. Such different powders may have different characteristics, such as different average particle sizes, different minimum and maximum particle sizes, different coefficient of friction, different angle of repose and the like. In some implementations, non-powdered build materials such as gels, pastes and slurries may be used.

The disclosed example build chambers may be provided in the form of modular units that are interchangeably inserted into slots or openings of a larger 3D printing system. In yet other implementations, the disclosed example build chambers are integrated into and as part of 3D printing systems, wherein the build chamber is not removable or separable as a module from the 3D printing system. During printing, the 3D printing system solidifies selected portions of each successively formed layer of build material provided by the build chamber. Such portions may be solidified using various suitable solidification techniques such as fusing agent deposition and heating systems, binder agent deposition systems, laser sintering systems and the like.

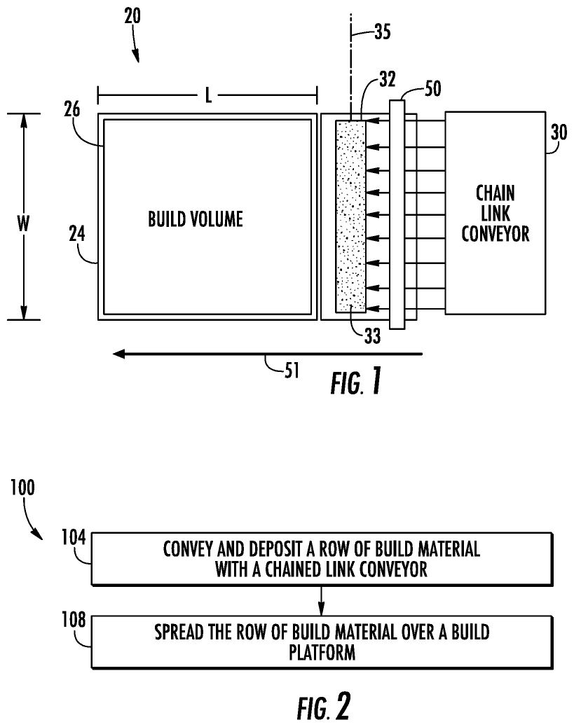

FIG. 1 is a top view schematically illustrating portions of an example 3D printing system build chamber 20. As described above, 3D printing system build chamber 20 may be part of a modular unit that is interchangeably insertable into a slot of a larger printing system that carries out the solidification of the selected portions of each successive layer of build material. In yet other implementations, build chamber 20 may be non-removably integrated into or as part of a larger 3D printing system. Build chamber 20 comprises build volume 24, chain link conveyor 30 and spreader 50.

Build volume 24 comprises a container for containing the consecutively formed layers of build material as well as the solidified portions of the build material that form the three-dimensional product or products. Build volume 24 has a length L, a width W and a depth D. The depth D extends from an underlying build platform 26 upon which layers of build material are formed. In implementations where build platform 26 is movable, the depth D may vary depending upon the positioning of the underlying platform 26.

Chain-link conveyor 30 delivers build material to lifter 140 from a build material supply. For purposes of this disclosure, a “chain-link conveyor” refers to a series of links in the form of discs, paddles, beads or other structures flexibly linked or chained together so as to form material conveying pockets between the links, wherein the chain of links is pulled or pushed over an underlying floor along a path of the conveyor by a conveyor drive. In some implementations, consecutive links of the “chain-link conveyor” may be flexibly linked or chained by intervening flexible segments, such as flexible wire, cable, cords, bands or the like. In some implementations, the consecutive links may be in the form of closed circular, rectangular or oval loops, wherein each loop extends through the interior space of the consecutive leading and trailing loops, flexibly chaining the loops together, and wherein the remaining interior space of each loop receives and conveys build material.

To facilitate pushing or pulling of the chain-link conveyor, the conveyor drive may comprise sprockets or other structures driven by a motor, wherein the sprockets or other structures that engage the links to push/pull the chain of links and flexible segments (when provided) along the path. The underlying floor may be provided by a tube that surrounds the links or may be provided by a floor having an open top. In implementations where the links are joined by intervening flexible segments, spaces between the links or within loops of the links form the material conveying pockets adjacent the intervening flexible segments, receive build material while one of the two adjacent links (depending upon the direction in which the chain link conveyor is moving) pushes the build material in the adjacent pocket as a chain-link conveyor is being pulled or pushed along its path.

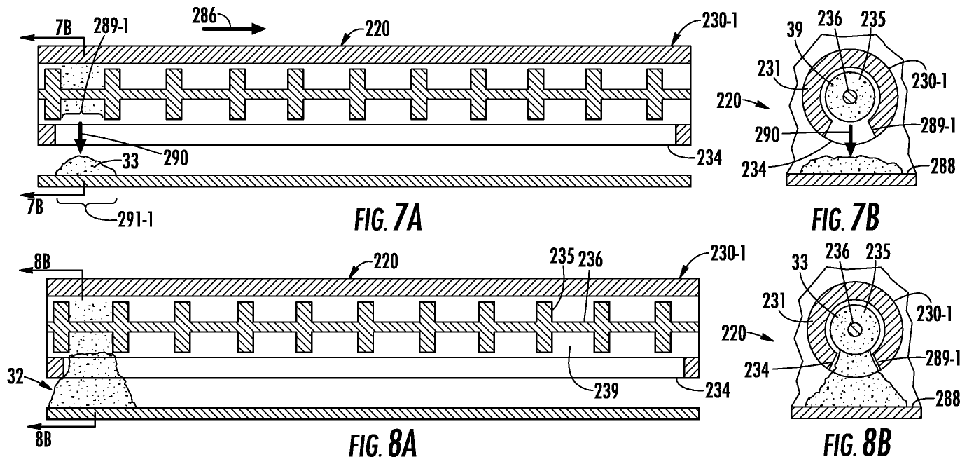

The floor may include a discharge opening or multiple discharge openings through which the carried build material is released or discharged. In implementations where the links and flexible segments move through a tube, portions of the tube may likewise include an input opening or multiple input openings through which build material may enter the tube for conveyance. Due to the flexible segments, the chain-link conveyor 32 can travel along a multitude of different linear and/or non-linear paths, and along multiple bends or turns, while conveying build material. In addition, as described in more detail in FIGS. 7A-10B below, the chain-link conveyor 32 may discharge or release the carried build material through an elongated discharge opening in a sequential fashion along its path so as to form a line or row of discharged build material. In one implementation, the role of build material is formed at a height above or at the top of the build volume, ready for spreading across the build platform. In another implementation, the role build material is formed at a height below the top of the build volume or below the top of the build volume, wherein the row is lifted for being spread over the build platform.

In one implementation, row 32 of build material 33 may have a length along axis 35 that extends across at least a majority of the width W of build volume 24. Chain-link conveyor 30 has an elongate discharge opening that is to form a row 32 of build material 33 having a length along axis 35 that is within 80% of the width W of build volume 24. In yet another implementation, the discharge opening of chain-link conveyor 30 is to form a row 32 of build material 33 having a length equal to the width W of build volume 24. Because chain-link conveyor 30 forms a row 32 of build material 33 extending along the edge of build volume 24 in a direction along the width W of build container 24, build chamber 20 may omit or may reduce the use of components such as vibrators, graders or compactors to distribute build material along the width W of build container 24. As a result, build chamber 24 may be more compact and less costly.

Spreader 50 comprises a device that is movable along the length L of build volume 24 and across top 28 of build volume 24 in the direction indicated by arrow 51 so as to spread build material 33 over build volume 24 forming a new layer of build material 33 directly upon the underlying platform that forms a floor of build volume 24 or directly upon the most recently formed layer of build material 33 which may or may not have solidified portions In one implementation, spreader 33 comprises a bar. In another implementation, spreader 33 may comprise a roller. Spreader 32 may be movable across build volume 24 by an actuator such as a pneumatic cylinder-piston assembly, electric solenoid or other actuation mechanisms to move spreader 32.

FIG. 2 is a flow diagram of an example build chamber layer forming method 100. Method 100 facilitates the forming of a build material layer for a 3D printing system using a more compact and less complex build chamber. Although method 100 is described in the context of being carried out using build chamber 20, it should be appreciated that method 100 may be carried out using any of the build chambers described hereafter or using other similar build chambers.

As indicated by block 104, chain-link conveyor 30 conveys and deposits a row 32 of build material 33 along the length of a lifter 140. As described above, row 32 of build material 33 may have a length along axis 35 that extends across at least a majority of the width W of build volume 24. Chain-link conveyor 30 has an elongate discharge opening that is to form a row 32 of build material 33 having a length along axis 35 that is within 80% of the width W of build volume 24. In yet another implementation, the discharge opening of chain-link conveyor 30 is to form a row 32 of build material 33 having a length equal to the width W of build volume 24. Because chain-link conveyor 30 forms a row 32 of build material 33 extending along the edge of build volume 24 in a direction along the width W of build container 24, build chamber 20 may omit or may reduce the use of components such as vibrators, graders or compactors to distribute build material along the width W of build container 24. As a result, build chamber 24 may be more compact and less costly.

As indicated by block 112, spreader 50 spreads the row 32 of build material 33 on top of the lifter 140 across the top 28 of build volume 24. Spreader 50 has a length correspond to the length of row 32. In one implementation, a single pass of spreader 50 across the top of build lives 24 creates a layer of build material ready for the solidification of portions by the 3D printing system. In another implementation, spreader 50 may reciprocate back and forth across top 28 or across portions of top 28 to form the layer of build material 33.

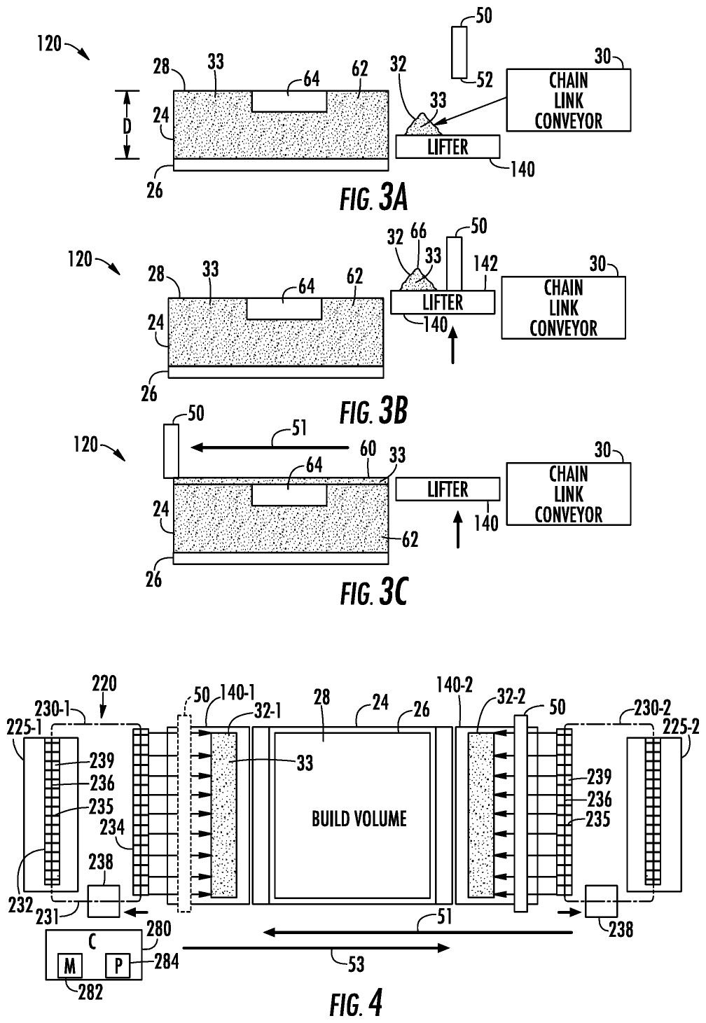

FIGS. 3A-3C are side view schematically illustrating portions of an example 3D printing system build chamber 120. Build chamber 120 is similar to build chamber 20 described above except the build chamber 120 additionally comprises lifter 140. Those remaining components of build chamber 120 which correspond to components of build chamber 20 are numbered similarly and/or are shown in FIG. 1.

Lifter 140 comprises a mechanical device to raise or lift the row of build material from below the top 28 of build volume 24 to a height proximate to the top 28. Lifter 140 extends along axis 35 and has a length along axis 35 so as to lift the formed row 32 of build material 33 as a row. In one implementation, lifter 140 may have a length along axis 35 no less than the length of the row 32 to be lifted.

Lifter 140 facilitates the formation of row 32 by chain-link conveyor 30 at a height below top 28 such that valuable overhead space above build volume 28 may be conserved for other componentry of the three-dimensional printing system in which build chamber 20 is employed. For example, space above build volume 24 may be utilized for the components of the 3D printing system that selectively solidify portions of the build material. In addition, the use of lifter 140 facilitates a lower positioning of chain-link conveyor 30, reducing the height of build chamber 20.

As will be described hereafter, lifter 140 may comprise a ram which underlies and lifts build material 33. In another implementation, lifter 140 may comprise a rotating vane which lifts build material 33. In yet other implementations, lifter 140 may comprise other mechanisms to vertically lift or raise build material 33 from a height below top 28 to a height at which portions of the row 32 extend above top 28.

FIGS. 3A, 3B and 3C further illustrate the formation of a new layer 60 of build material 33 (shown in FIG. 3C) over previously formed layers 62 of build material 33, portions 64 of which may have been solidified. As shown by FIG. 3A, chain-link conveyor forms the row 32 of build material 33 at a height below top 28 of build volume 24. In one implementation, the row 32 may be formed directly upon lifter 140. In another implementation, the row 32 may be formed upon a holding container, wherein lifter 140 moves into or is rotated into the holding container to engage and lift the row 32 out of the holding container.

FIG. 3B illustrates the actuation of lifter 140 to lift the row 32 of build material 33 to a height where the crown 66 of row 32 is at a height above the top 28 of build container 24. In the example illustrated, the floor 42 of lifter 140 is elevated above the top 28 of build container 24. FIG. 2C illustrates the movement of spreader 50 across the length L of build volume 24 so as to push build material 33 over layer 62, forming the new layer 60. In one implementation, lifter 50 has a lower surface 52 spaced above the current top 28 of build volume 24 by distance corresponding to the thickness of the layer of build material 33 to be formed. In one implementation, the spacing of the lower surface 52 relative to the current top of build volume 24 is adjustable to adjust the thickness of the layer of build material 33 being formed.

FIG. 4 is a top view of portions of an example build chamber 220. As with build chamber 20, build chamber 220 may be part of a modular unit that is interchangeably insertable into a slot of a larger printing system that carries out the solidification of the selected portions of each successive layer of build material. In yet other implementations, build chamber 220 may be non-removably integrated into or as part of a larger 3D printing system. In contrast to build chamber 20, build chamber 220 forms rows of build material 33 on opposite side edges of build volume 24 using dual lifters on opposite sides of build volume 24. As a result, the rows of build material may be alternately formed and alternately spread for faster build layer formation and faster 3D printing. The dual lifters on opposite sides of the build volume may also take up excess powder not used to form the current layer. As a result, additional mechanisms to reclaim such unused build material may be omitted. Build chamber 220 comprises build volume 24, build material supplies 225-1, 225-2 (collectively referred to as build material supplies 225), chain-link conveyors 230-1, 230-2 (collectively referred to as chain-link conveyors 230), lifters 140-1, 140-2 (collectively referred to as lifters 140), spreader 50 and build chamber controller 280. Build volume 24 is described above.

Build material supplies 225 contain a supply of build material for use in forming the multiple consecutive layers of build material within build volume 24. In one implementation, build material supplies 225 each comprise separate and distinct containers for containing build material. In another implementation, build material supplies 225 comprise different portions of a single continuous container for containing build material. In one implementation, one or both of build material supplies 225 extends below build volume, capturing build material that has fallen from build volume 24 during the forming of the layers within build volume 24. For example, build volume 24 may have a floor or bottom defined by a vertically movable platform, wherein one or both of build material supplies 225 receives and recovers build material that has fallen from the movable platform during the spreading of build material across build volume 24 to form the layers of build material during printing. In yet other implementations, one or both of build material supplies 225 may comprise a container remote from build volume 24 for containing or supplying build material that has not yet been placed in build volume 24.

Chain-link conveyors 230 (schematically shown) each comprise a single continuous chain-link conveyor extending along a continuous endless path that extends across a respective one of build material supplies 225 and that forms an elongate row of build material below the top of build volume 24 for being lifted to proximate the top of build volume 24 by a respective one of lifters 40. Although the path of each of conveyors 230 is illustrated as being generally oval or rectangular, in other implementations, the path may be convoluted or serpentine, having multiple bends, twists and turns. The path of conveyors 230 may extend in a single plane or may extend in multiple planes. For example, the path upstairs 230 may have portions that extend in a horizontal plane and portions that extend in a vertical plane to lift or lower build material.

As schematically shown by FIG. 4, each of chain-link conveyors 230 comprises an elongate endless tube 231 (closed portions shown by dot-dash lines) having an elongate input opening 232 and an elongate discharge opening 234. Tube 231 surrounds, encloses and guides movement of a series of links 235 in the form of discs, paddles, beads or other structures linked or chained together by intervening flexible segments 236, wherein the chain 237 of links 235 and flexible segments 236 is pulled or pushed through the tube 231 along a path of the conveyor by a conveyor drive 238 (schematically shown). The conveyor drive 238 may comprise sprockets or other structures driven by a motor, wherein the sprockets or other structures engage the links to push/pull the chain of links 235 and flexible segments 236 along the path.

Input opening 232 extends through the ceiling of the tube 231 above the chain of links 235 and flexible segments 236. Input opening 232 may face in a generally upward direction, facing the interior of the respective one of build material supplies 225, facilitating the inflow of build material through the input opening 232 into pockets 239, each pocket being formed between consecutive links 235 and adjacent to or about the flexible segment 236 connecting the consecutive links 235. As the chain of links 235 and segments are driven by drive 238, the rearward link 235 pushes and conveys build material within the adjacent pocket 239 in a forward direction along the path.

In the example illustrated, input opening 232 exposes the underlying chain of links 235 and segments 236 to the interior of the respective build material supply 225 along a majority of the dimension of build material supply 225 across which the respective conveyor 230 extends. In the example illustrated, input opening 232 extends along the floor of the build material supply 225-1, 225-2 across greater than 80% and nominally all of the dimension or length of the build material supply 225-1, 225-2. As a result, in contrast to a single port or inlet which may promulgate rat holes in the build material, input opening 232 forms an elongate continuous inlet. The elongate continuous inlet inhibits the bridging or rat holing of build material within the build material supply and/or facilitates a collapse of any rat holes that do form, providing a more reliable and consistent supply of build material to the respective lifter 140-1, 140-2 and build volume 24.

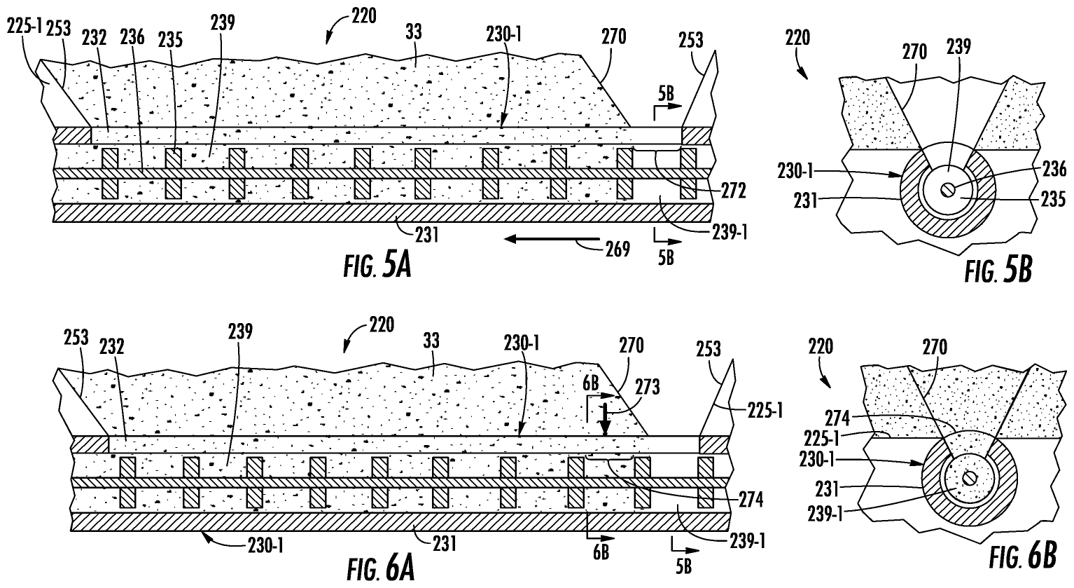

FIGS. 5A-5C illustrate how each of chain-link conveyor 230-1 withdraws build material from its build material supply 225-1, while inhibiting the formation of or promoting the collapse of any formed rat holes. In the example illustrated, build material supply 225-1 is illustrated as having internal slopes sidewalls 253. In other implementations, such sloped internal sidewalls may have other angles or be vertical. Although each of the links 235 is illustrated as being a circular disk, in other implementations, each of links 235 may comprise other forms of links such as beads or the like.

As shown by FIGS. 5A and 5B, during pushing or pulling of links 235 in the direction indicated by arrow 269, the pockets 239 eventually withdraw the build material from a single point above a first portion or segment 272 of the input opening 232. When a rat hole 270 initially forms over the first axial portion or segment 272 of the elongate input opening 232, subsequent pockets, such as the illustrated pocket 239-1, traveling beneath the rat-hole 270 will not fill with powder build material. However, as shown by FIGS. 12A and 6B, when the empty pocket 239-1 is pulled/pushed to the next downstream consecutive segment 274 of the input opening 232, outside the rat hole 270 or beneath the build material forming the cone-shaped surface, the build material will fall into it the empty pocket 239-1 as indicated by arrow 273. In such an event, the rat hole 270 may collapse or avalanche. In circumstances where the rat hole 270 does not collapse, a second rat hole may develop above the second segment of the input opening. If this happens, the pocket is pulled/pushed to the next downstream consecutive segment of the input opening for receiving build material. This process repeats as the conveyor is pushed/pulled below the elongate input opening and across the build material supply. Each of the chain-link conveyors of this disclosure may facilitate withdrawal of build material from a build material supply in a similar fashion.

Discharge opening 234 extends through a floor portion of tube 231 and above an underlying surface upon which the row 32-1, 32-2 of build material 33 is to be formed. In one implementation, the underlying surface may be the top surface of a respective one of lifters 40. In another implementation, the underlying surface may be the bottom or floor of a holding container, wherein the lifter 1140-1, 140-2 comprises a rotating vane that when rotated, scoops and lifts the row 32, as a row, to height proximate the top of build volume 24.

FIGS. 7A-10B illustrate how each of chain-link conveyors 230-1, 230-2 sequentially discharges build material so as to form a row of build material. FIGS. 7A-10B illustrate the pushing or pulling of links to 35 in a direction indicated by arrow 286. As described above, the elongate discharge opening 234 is spaced above and underlying surface 288 which may itself be provided by an upper surface of a lifter 1140-1, 140-2 in the form of a ram or may be provided by the floor of a tray or holding container which lifts the row, as a row up and out of the holding container. The build material 33 is released, under the force of gravity, through discharge opening 234 in a sequential fashion along its path so as to form the row 32-1, 32-2 of discharged build material 33. Each of the chain-link conveyors of this disclosure may form a row of build material on the top of a ram or within a holding container in a similar fashion.

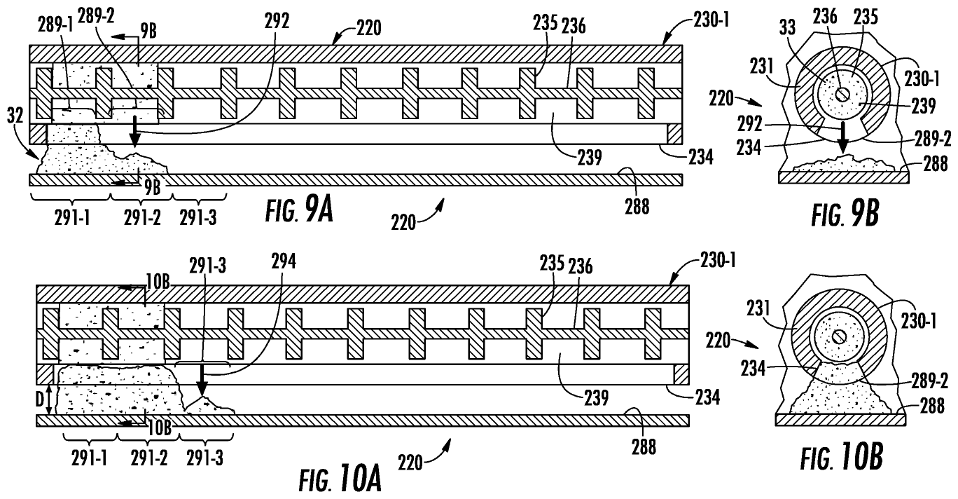

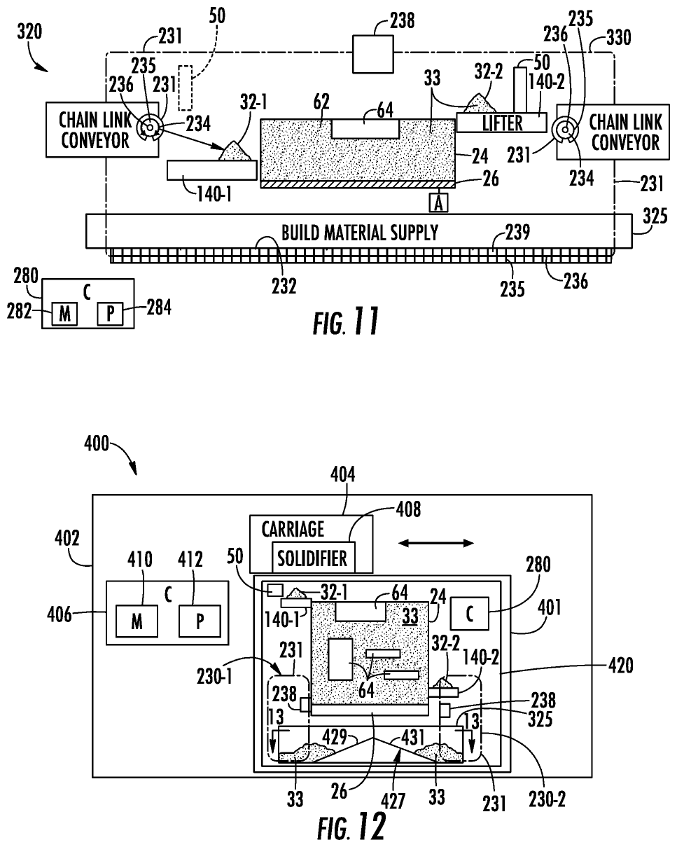

As shown by FIGS. 7A and 7B, when a row is initially being formed on surface 288, each of the pockets containing build material 33 deposits its individual “load” at a first location on surface 288 through a first portion or segment 289-1 of discharge opening 234 as indicated by arrow 290, forming a first axial portion 291-1 of the row 32 being formed. As shown by FIGS. 14A and 8B, the pile or amount of build material 33 at the first location along surface 288 eventually builds up and rises until the discharged build material at the first portion forms a floor underlying the corresponding first portion 289-1 of the elongate discharge opening 234. Thereafter, the pockets 239 of the chain-link conveyor 230-1 may convey additional build material over the floor formed by the discharged build material at the first portion, wherein the pockets 239 of the chain-link conveyor 230-1 discharge their loads through a second portion or segment 289-2 of discharge opening 234 as indicated by arrow 292, forming a second axial portion 291-2 of the row 32 being formed. As shown by FIGS. 15A and 9B, the pile or amount of build material 33 at the second location along surface 288 eventually builds up and rises until the discharged build material at the second portion forms a floor underlying the corresponding first portion 289-2 of the elongate discharge opening 234. Thereafter, the pockets 239 of the chain-link conveyor 230-1 may convey additional build material over the floor formed by the discharged build material at the second portion, wherein the pockets 239 of the chain-link conveyor 230-1 discharge their loads through yet a third portion or segment 289-3 of discharge opening 234 as indicated by arrow 294, forming a third axial portion 291-3 of the row 32 being formed. This process repeats until a line or row 32 of build material, corresponding to the path and length of the elongate discharge opening 234 has been formed.

In such an implementation, the vertical spacing D between the bottom edge of the links 235 and the surface underlying the links (and the chain-link conveyor) control the height of the thus formed row of build material. In such an implementation, the width or diameter of the individual links to 35 and the width of the discharge opening 234 may control the width of row 32-1, 32-2. The width and the height of 32-1, 32-2 control the volume of build material per given unit length of row 32-1, 32-2. By appropriately designing the width of the links 235, the width of the discharge opening 234 and the spacing between the lower edge of the links to 35 and the underlying surface, the volume or amount of build material per unit length of the row 32-1, 32-2 may be controlled so as to provide sufficient build material for forming a layer yet reduce excessive amounts of build material that do not form the layer of build material.

In the example illustrated, the discharge openings 234 of conveyors 230-1, 230-2 form rows 32-1, 32-2, respectively of build material 33. Rows 32 of build material 33 may each have a length that extends across at least a majority of the width W of build volume 24. Each of rows 32 has a length that is within 80% of the width W of build volume 24. In yet another implementation, each of rows 32 has a length equal to the width W of build volume 24. Because chain-link conveyors 230 form rows 32 of build material 33 extending along opposite edges of build volume 24 in a direction along the width W of build container 24, build chamber 20 may omit or may reduce the use of components such as vibrators, graders or compactors to distribute build material along the width W of build container 24. As a result, build chamber 220 may be more compact and less costly.

In one implementation, the lower edges of the links 235 of the chain-link conveyor 30 are vertically spaced from an underlying surface, whether it be the upper surface of lifter 140, such as in the case of a ram, or the floor of a holding container, such as in the case of a pivoting or rotating vane that scoops and lifts the row of build material off of the floor of the holding container, by a distance corresponding to the selected height of the row 32-1, 32-2 of build material 33 to be formed. In one implementation, the height of row 32-1, 32-2 is selected such that the volume of the row 32-1, 32-2 of build material, when spread by spreader 40, forms a sufficiently uniform layer across the top of build volume 24. The volume of row 32 is controlled such that the amount of excess build material that is spread and that does not form the layer is reduced or minimized. In one implementation, row 32 may have a height of 5 mm and no greater than 50 mm. The width of each of rows 32 controlled by the width or diameter of the links to 35 and the width of the discharge opening 234 is 5 mm and no greater than 100 mm.

Lifters 140-1, 140-2 are each substantially similar to lifter 140 described above. Lifters 140-1, 140-2 extend along opposite sides or opposite edges of build volume 24. Lifters 140 present rows 32 of build material proximate to the opposite side edges of build volume 24 for being spread by spreader 50.

Spreader 50 is described above. In the example illustrated, spreader 50 is movably driven by a motor and rack and pinion drive, electric solenoid, cylinder-piston assembly or other linear drive. In the example illustrated, spreader 50 is reversible in that spreader 50 may be selectively driven in each of the directions indicated by arrows 51 and 53. In particular, spreader 50 is movable in the direction indicated by arrow 51 to spread row 32-2 of build material 33 over build platform 26 and across build volume 24 to form a first layer of build material. Spreader 50 is movable in the direction indicated by arrow 53 to spread row 32-1 over build platform 26 and across the top of build volume 24 to form a second different layer of build material. In some implementations, portions of the layer of build material formed by row 32-2 are solidified prior to the spreading of row 32-1 by spreader 50. In yet other implementations, two layers of build material formed from both of rows 32-2 and 32-1 may be formed before a solidification process is carried out by the 3D printing system. In some implementations, build chamber 220 may comprise two different spreaders 50, a first spreader for spreading the build material of row 32-1 and a second different spreader for spreading the build material of row 32-2.

Controller 280 controls the operation of build chamber 220. Controller 280 comprises a memory 282 containing instructions for directing a processing unit 284 to output control signals to various actuators (motors and the like) to control the driving of conveyors 230 by drives 238, to control the movement and positioning of lifters 140 and to control the movement of spreader 50. In one implementation, controller 280 outputs control signals causing chamber 220 to carry out method 100 described above. In one implementation, controller 280 controls the height of lifter 140 relative to the top 28 of build volume 24 to control the thickness of the layer of build material 33 being formed. In one implementation, controller 280 is provided as part of the modular unit formed by build chamber 220. In another implementation, controller 28 is provided as part of the overall larger 3D printing system which removably receives build chamber 220 or in which build chamber 220 is non-removably integrated.

FIG. 11 is a side view schematically illustrating portions of an example build chamber 320. FIG. 11 illustrates an example implementation where the floor of build volume 24 is formed by a vertically movable build platform 26 that is raised and lowered by an elevator or vertical actuator 326, wherein a build material supply 325 underlies the build platform 26 and wherein a single chain-link conveyor 330 conveys build material 33 from the build material supply 325 to each of two lifters 140-1, 140-2 located on opposite sides of build volume 24.

Chain-link conveyor 330, which is similar to chain-link conveyor 230-1 or 230-2 is endless and continuously extends across and below build material supply 325 and over and above each of lifters 140-1, 140-2 so as to form rows 32-1, 32-2 of build material 33 for being lifted by lifters 140 from below the top of build volume 24 to proximate the top of build volume 24 for being spread by spreader 50. In such an implementation, the drive 238 may be operated in reverse directions, facilitating the alternating supply of build material to the lifters 140-1, 140-2 on the opposite sides of build volume 24. Although chain-link conveyor 330 is illustrated as extending in a generally rectangular path and a single vertical plane, chain-link conveyor 330 may alternatively extend in a convoluted or serpentine path below build material supply 325 and may extend in a horizontal plane between lifter 140-1 and lifter 140-2.

The operation of build chamber 320 may be controlled by controller 280 described above. In one implementation, controller 280 outputs control signals such that while one of rows 32 is being spread across the top of build volume 24 and/or is being solidified by the 3D printing system, the other of rows 32 is being formed by chain-link conveyor 330 and/or is being raised by its respective lifter 140. Such alternating operation facilitates faster building of build material layers and faster 3D printing.

FIGS. 12-14 illustrate portions of an example 3D printing system 400. FIG. 12 is a sectional view schematically illustrating portions of the example 3D printing system 400 which includes an example build chamber 420 formed as a modular unit that is removably or interchangeably received within an opening or slot 401 of system 400. In other implementations, build chamber 420 may be non-removably integrated as part of system 400.

In the example illustrated, system 400 carries out solidification processes upon the individual layers of build material provided by build chamber 420. In addition to build chamber 420, system 400 comprises solidification unit 402 which provides the chamber receiving slot 401. Solidification unit 402 comprises carriage 404 and controller 406. Carriage 404 comprises a platform or other structure that is movably supported over and above slot 401 and over and above build chamber 420. Carriage 404 is selectively positioned opposite to selected portions of the layers of build material provided by build chamber 420 by a motor and a rack and pinion drive, an electric solenoid, a hydraulic-pneumatic cylinder a piston assembly or the like to facilitate the solidification of selected portions of the layers of build material provided by build chamber 420.

As schematically shown by FIG. 12, carriage 404 carries a solidifier 408. Solidifier 408 carries out solidification of selected portions of the individual layers of build material provided by build chamber 420. In one implementation, solidifier 408 comprises fusing agent deposition and heating systems, binder agent deposition systems, laser sintering systems and the like which operate on the underlying portions of the build layers presented by chamber 420.

Controller 406 controls the positioning of carriage 404 as well as the solidification of portions of the build layers by solidifier 408. Controller 406 comprises memory 410 and processing unit 412. Memory 410 contains instructions for directing processing unit 412 to carry out control determinations and to output control signals to carriage 404 and solidifier 408. For example, instruction contained in memory 410 may direct processing unit 412 to access a file describing the composition, shape and size of a three-dimensional object to be formed on a layer-by-layer basis in build chamber 420. Based upon information read from the file, processing unit 412, following instruction contained in memory 410, output signals to carriage 404 to then position solidifier 408 opposite to appropriate portions of the layer of build material. Such instructions further direct solidifier 402 carry out a solidification process on selected portions of the layer of build material currently being presented by build chamber 420. This process is repeated layer by layer until the three-dimensional object defined in the file has been formed. In some implementations, once each three-dimensional object has been formed within the build chamber 420, the build chamber 420 may be removed from solidification unit 402 and transferred to a processing station where the formed objects are removed and the unused build material is recovered and potentially recycled.

Build chamber 420 is similar to build chamber 320 described above except that lifters 140-1, 140-2 are individually supplied with build material by dedicated and distinct chain-link conveyors 230-1, 230-2 (described above with respect to build chamber 220). In addition, the build material supply 325 is illustrated as additionally comprising a double sided ramp floor 427. Those remaining components of build chamber 420 which correspond to components of build chamber 220 or build chamber 320 are numbered similarly. Although controller 280 (described above) is illustrated as being part of the chamber 420, in another implementation, controller 280 may alternatively be provided as part of solidifier 402, wherein controller 280 communicates with the controlled components of build chamber 420 using a communication connection between build chamber 420 and solidification unit 402. In yet other implementations, the control functions of controller 280 may alternatively be carried out by controller 406.

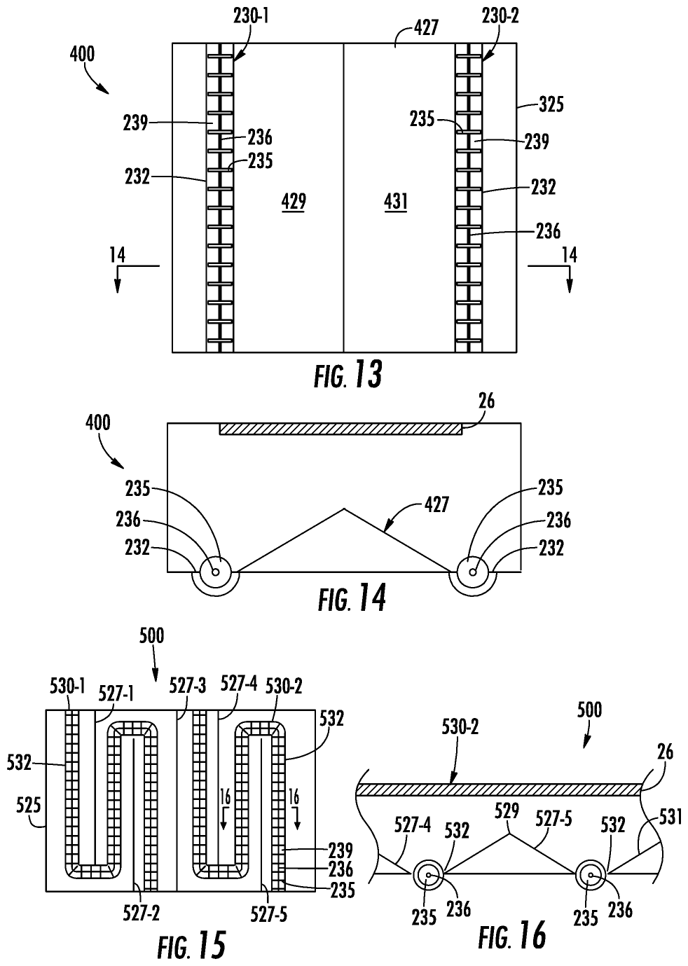

As shown by FIGS. 13 and 14, floor 427 has a first ramp floor portion 429 declining towards a first side of supply 325, towards the input opening 232 (shown in FIG. 4) of chain-link conveyor 230-1 and a second ramp floor portion 431 declining towards the input opening 232 of chain-link conveyor 230-2. Floor portions 429,431 direct build material 33 which has fallen from platform 26 overhead supply 325 towards the input openings 232 for forming subsequent build material layers within build chamber 24.

As further shown by FIG. 13, each of chain-link conveyors 230 extends completely across the floor of build material supply 325, parallel to the apex of the double-sided ramp floor 427. Chain-link conveyors 230 extend proximate to the opposite edges of platform 26 such that material falling from platform 26 initially falls upon or near either of the two chain-link conveyors 230. As shown by FIG. 14, chain-link conveyors 230 are each partially recessed below the floor of supply 325, facilitating the input of build material into the pockets 239 of conveyors 230 through the force of gravity.

The use of the double sided ramp floor 427 and the chain-link conveyor 230-1, 230-2, which have input openings 232 that extend across an a majority, if not all of, the dimension of the floor, facilitates a continuous and reliable supply of build material to build volume 24 with a lower height build supply 325. The lower height of build supply 325 may further facilitate a deeper build volume 24 and/or a more compact and lower height build chamber 420 and/or system 400.

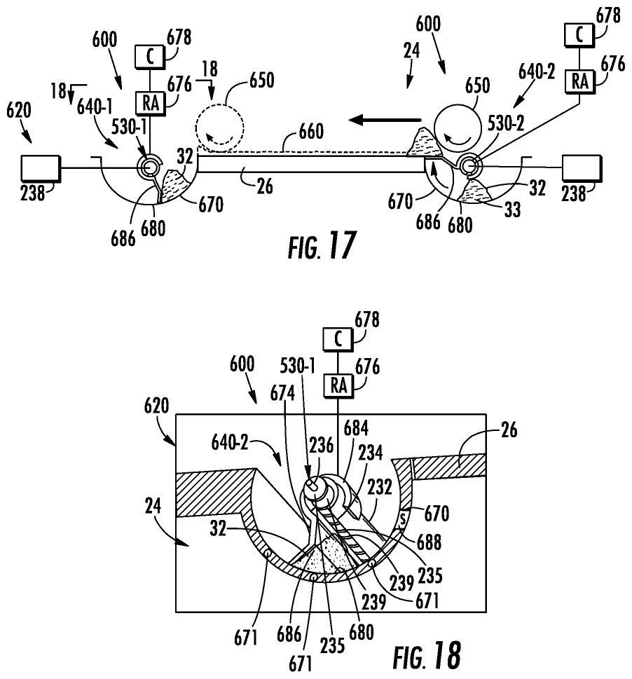

FIGS. 15 and 16 illustrate portions of an example 3D printing system 500. System 500 illustrates how the use of chain-link conveyors may more reliably and thoroughly remove build material from a build material supply, potentially facilitating the use of lower height build supplies to increase build volume depth and/or reduce the height of the overall 3D printing system. System 500 is similar to system 400 except that system 500 comprises chain-link conveyors 530-1, 530-2 (collectively referred to as conveyors 530) and build material supply 525 in place of chain-link conveyors 230-1, 230-2 in build supply 325, respectively. Those remaining components of system 500 which correspond to system 400 are numbered similarly and/or are shown in FIG. 12.

Chain-link conveyors 530 are each similar to chain-link conveyors 230 described above except that chain-link conveyors 530 each extend in a serpentine path along the floor of build material supply 525. Each of chain-link conveyors 530 has an input opening 532 extending over the underlying links 235 and segments 236 to facilitate the entry of build material into the conveying pockets 239 through the use of gravity. In the example illustrated, each of input openings 532 also has a serpentine shape, following the serpentine path of the corresponding chain-link conveyor. The serpentine path facilitates the positioning of input opening 532 across a larger percentage of the total surface area of the floor of build material supply 525, further inhibiting the formation of build material bridges or rat holes, facilitating more reliable supply of build material from supply 525.

As further shown by FIGS. 15 and 16, the floor of build material supply 525 comprises double-sided ramp floors 527-1, 527-2, 527-3, 527-4 and 527-5 (collectively referred to as floors 527). Each of floors 527 is positioned between consecutive legs of the serpentine paths of conveyors 530. Floors 527-1 and 527-2 are positioned between consecutive legs of the serpentine path of conveyor 530-1. Likewise, floors 527-4 and 527-5 are positioned between consecutive legs of the serpentine path of conveyor 530-2. Floor 527-3 is positioned between legs of the different serpentine paths of conveyors 530-1 and 530-2.

Each of floors 527 has an apex 529 from which two sides decline towards the discharge opening 532 of an adjacent portion of the conveyor 530. The declining sides direct build material, under the influence of gravity, towards the two conveyor legs located on opposite sides of the apex 529. As shown by FIG. 16, the opposing internal sides of the floor of build material supply 525 each include an inwardly declining ramp portion 531 which further directs material only internal sides of build material supply 525 towards an adjacent input opening 532 of an adjacent conveyor 530.

FIGS. 17 and 18 illustrate portions of an example 3D printing system 600 during various stages of build material row formation. Portions of an example build chamber 620 of system 600 are illustrated. FIGS. 17 and 18 illustrate an example lifter that may be utilized in any of the described build chambers or 3D printing systems as lifter 140. System 600 is similar to system 500 described above except that system 600 specifically includes lifters 640-1 and 640-2 (collectively referred to as lifters 640) and spreader 650 (specifically shown as a roller) in place of lifters 140-1, 140-2 and spreader 50 described above. Those remaining components of system 600 are numbered similarly and/or are shown in FIGS. 6, 9 and 10.

Similar to lifters 40, lifter 640 extend on opposite sides of build volume 24, on opposite sides of platform 26. Each of lifters 640 comprises a holding container 670, a rotatable vane 674, a rotary actuator 676 and controller 678. The holding container 670 has a semi-cylindrical shaped interior that extends along an adjacent to the top of build volume 24. In FIG. 17 which illustrates platform 26 elevated to the top of build volume 24, container 670 has an upper end adjacent to the top of platform 26. As layers of build material are built upon platform 26 and as platform 26 is lowered, the upper edge of build container 670 may extend adjacent to the top of the topmost layer of build material within build volume 24.

Each of holding containers 670 comprises a floor 680 extending below the discharge opening 234 of its respective conveyor 530. Floor 680 is spaced from discharge opening 234 by a distance corresponding to the height of the row of build material to be formed within container 670 which corresponds to the height of the row of build material that is to be raised by rotatable vane 674 to the top of build volume 24 for being spread across build volume 24.

In the example illustrated, holding containers 670 further comprise or extend adjacent to heaters 671 that apply heat to the build material within container 670 to remove moisture within the build material. In some implementations, the heaters may also assist in avoiding thermal variations across the bed and/or prematurely solidifying the parts being printed. Example heaters 671 may comprise electrical resistors that emit heat that is thermally conducted through the walls of container 670 is the build material within container 670. In other implementations, heaters 671 may be omitted.

Rotatable vane 674 is rotatably driven by rotary actuator 676. In the example illustrated, rotatable vane 674 is rotatably supported about tube 232 by a pair of C-shaped collars 684 (one of which is shown in FIG. 18) at opposite end portions of tube 232 and opposite ends of container 670. Each rotatable vane 674 further comprises a blade portion 686 which rotates along the cylindrical interior of container 670. Blade portion 686 may extend along a majority if not all of the length of discharge opening 234, corresponding to the length of the row of build material to be formed within container 670 and the length of the row of build material to be lifted by lifter 640-2. Blade portion 686 is angled so as to extend substantially parallel to and level with the top of platform 26 and/or the top of build volume 24 when elevated as shown with respect to lifter 640-2 in FIG. 17.

Rotary actuator 676 comprises a mechanism operably coupled to rotatable vane 674 so as to rotate vane 674 about the axis of the conveyor 530-1, 530-2. In one implementation, rotary actuator 676 may comprise any suitable drive mechanism such as a stepper motor, rack and pinion arrangement, and the like. In one implementation, actuator 676 may additionally be coupled to a position determination sensor such as an angular encoder, to enable the angular position of the blade portion 686 to be accurately controlled and determined.

Controller 678 outputs control signals to rotary actuator 676 controlling the positioning of blade portion 686. In one implementation, controller 678 further outputs control signals controlling the operation of drive 238 of chain-link conveyor 530-2 and spreader 650. Controller 678 may be similar to controller 280, including memory 282 processing unit 284 (shown in FIG. 11), wherein the memory 282 contains instructions for directing the processing unit 284 to output the control signals.

The following is an example of the operation of chain-link conveyor 530-2 and lifter 640-2 for forming a layer of build material in build volume 24. It should be appreciated that same operation may be carried out by chain-link conveyor 530-1 and lifter 640-1. When preparing to form a layer of build material in build volume 24, controller 678 outputs control signals causing drive 238 (shown in FIG. 4) to push or pull chain-link conveyor 640-2 so as to convey build material from build volume 525 and discharge build material into the corresponding build material holding container 670. The pockets 239 of the chain-link conveyor 640-2 may continually discharge build material at a first portion of a line upon the floor 680 of holding container 670 until the discharged build material at the first portion forms a floor underlying a corresponding first portion of the elongate discharge opening. Thereafter, the pockets of the chain-link conveyor may convey additional build material over the floor formed by the discharged build material at the first portion, wherein the pockets of the chain-link then discharge build material at a second consecutive portion of the line until the discharge build material at the second portion builds up to form a second floor underlying a corresponding second portion of the elongate discharge opening. This process repeats until a line or row of build material, corresponding to the path and length of the elongate discharge opening has been formed within holding container 670 along its floor 680 as shown on the right side of FIG. 17 which illustrates the row 32 in broken lines residing on the floor 680 of holding container 670.

In such an implementation, the vertical spacing between the bottom edge of the links and the floor 680 underlying the links (and the chain-link conveyor) control the height of the thus formed row of build material. In such an implementation, the width or diameter of the individual links and the width of the discharge opening 234 may control the width of row 32. The width and the height of row 32 control the volume of build material per given unit length of row 32. By controlling the width of the links, the width of the discharge opening and the spacing between the lower edge of the links and the underlying surface, the volume of billed material 33 along row 32 may be controlled so as to provide sufficient build material for forming the build material layer yet reduce excessive amounts of build material that do not form the build material layer.

Controller 678 determines when the row of build material is holding container 670 has been completed. In one implementation, controller 678 determines that the row 32 has been completed based upon the lapse of time in the given rate at which build material is conveyed by conveyor 530-2. In another implementation, controller 678 may receive signals from a level sensor 688 (schematically illustrated) located within holding container 670. For example, in one implementation, sensor 688 may comprise a photo emitter-detector at an end portion of holding container 670 that senses when the height of the mound forming the end of row 32 blocks the emitter-detector.

In yet another implementation, controller 778 may not determine when the row of build material on the floor holding container 670 has been completed. In such an implementation, the chain-link conveyor may be continuously driven. When the holding container has been sufficiently filled with build material so as to form a floor of build material beneath the entire length of the chain-link conveyor, the build material powder automatically stops discharging (since there is nowhere for the powder to fall into) and the build material powder is just carried back to the supply. Once in the supply area, the pocket cannot pick up any new powder, and continues back up to the discharge area again and again until there is room to discharge (when a new row of build material is being formed following the lifting of the old row of build material). Depending on the drive mechanism, however, some build material powder still in the pocket may be displaced (for example, by a sprocket tooth). This is not an issue as the gap will be filled.

Once the row 32 of build material 33 has been formed along the length of the holding container 670, controller 678 outputs control signals causing rotary actuator 676 to rotate blade portion 686. The left side of FIG. 17 illustrates a formed row 32 being engaged and lifted by the blade portion 686 of lifter 640-1. The right side of FIG. 17 illustrates a formed row 32 of build material 33 having been lifted by blade portion 686 of lifter 640-2. Blade portion 686 of lifter 640-2 is illustrated as being level with or slightly above the top of platform 26 so as to lift the completed row 32 to a height at the top of build volume 24 (at a height adjacent to the top of platform 26 or adjacent to the topmost previously formed layer of build material within build volume 24. As shown by broken lines, while blade portion 686 is retained at this height, controller 678 outputs control signals to an actuator that drives spreader 650 across blade portion 676 and across the top of build volume 24 so as to spread the row 32 of build material 33 across the top of build volume 24, forming a new layer 660 (shown with an exaggerated thickness) of build material across the top of build volume 24. Any excess build material not used to form the current layer is pushed by spreader 650 into the opposite holding container 680 on the left side of build volume 24 for reuse. Such build material forms a part of the row of build material being formed in the opposite holding container 670 of lifter 640-1.

In the example illustrated, chain-link conveyor 530-2 has an elongate discharge opening so as to form a row 32 of build material 33. The bottom surfaces of the links of conveyor 30 are spaced from an underlying surface (the floor 680 of a holding container 670) by a distance corresponding to the height of row 32 and therefore the volume of build material for a given length of row 32. The row 32 of build material 33 may extend along an axis 35 (shown in FIG. 1) parallel to the width W of build volume 24. In some implementations, the row 32 of build material 33 may extend nonparallel to the width W of build container 24 or may extend along a curved or serpentine path.

The row 32 of build material 33 may have a length that extends across at least a majority of the width W of build volume 24. Chain-link conveyor 530-2 has an elongate discharge opening that is to form a row 32 of build material 33 having a length along axis 35 that is within 80% of the width W of build volume 24. In yet another implementation, the discharge opening of chain-link conveyor 530-2 is to form a row 32 of build material 33 having a length equal to the width W of build volume 24. Because chain-link conveyor 530-2 forms a row 32 of build material 33 extending along the edge of build volume 24 in a direction along the width W of build container 24, build chamber 620 may omit or may reduce the use of components such as vibrators, graders or compactors to distribute build material along the width W of build container 24. As a result, build chamber 24 may achieve a more consistent row height, may be more compact and may less costly. By reducing or avoiding reliance upon vibrators to spread material, the likelihood of the build material powder separating or segregating based upon varying powder particle sizes and weights is further reduced.

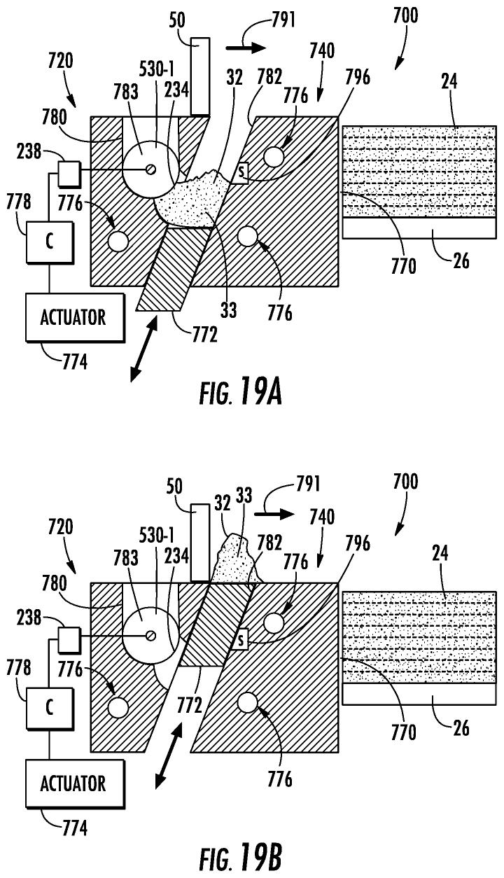

FIGS. 19A and 19B are sectional views schematically illustrating portions of an example 3D printing system 700. Portions of an example build chamber 720 of system 700 are illustrated. FIG. 19A illustrates the use of a ram as a lifter to lift a row of build material formed by a chain-link conveyor. System 700 is similar to system 500 described above except that system 700 specifically includes lifters 740 (one of which is shown) in place of lifters 140-1, 140-2 described above. Those remaining components of system 700 are numbered similarly and/or are shown in FIGS. 6, 9 and 10.

Lifter 740 comprises body 770, ram 772, actuator 774, heaters 776 and controller 778. Body 770 extends adjacent to the top of build volume 24. Body 774 forms a supply passage 780 and an internal lift passage 782. Supply passage 780 directs build material received from chain-link conveyor 530-1 to supply passage 782, above ram 772. In the example illustrated, supply passage 780 receives portions of chain-link conveyor 530-1. In other implementations, supply passage 780 may be located beneath the discharge opening of chain-link conveyor 530-1.

Lift passage 782 extends through body 770 and terminates at a height adjacent to the top of build volume 24. Lift passage 782 contains build material as a build material is being lifted by ram 772 through list passage 782.

Ram 772 slides within lift passage 782 and is raised and lowered by actuator 774. Actuator 774 may comprise any suitable actuator for raising and lowering ram 772. For example, actuator 774 may comprise a rack and pinion arrangement, an electric solenoid, a pneumatic cylinder-piston assembly or the like.

Heaters 776 comprise internally embedded heaters proximate to lift passage 782. Heaters 776 warm or heat build material within supply passage 782 to remove moisture from any build material within lift passage 782. In other implementations, supply passage 782, lift passage 784 and ram 772 may have other shapes. In some implementations, the heaters 776 may also assist in avoiding thermal variations across the bed and/or prematurely solidifying the parts being printed. In other implementations, heaters 776 may be omitted.

Controller 778 outputs control signals to actuator 774 for controlling the positioning of ram 772. In one implementation, controller 678 further outputs control signals controlling the operation of chain-link conveyor 530-1 and spreader 50. Controller 778 may be similar to controller 280, including memory 282 processing unit 284 (shown in FIG. 11), wherein the memory 282 contains instructions for directing the processing unit 284 to output the control signals.

The following is an example of the operation of chain-link conveyor 530-1 and an associated lifter 740 for forming a layer of build material in build volume 24. It should be appreciated that the described operation may likewise be carried out on the other side of build volume 24 by chain-link conveyor 530-2 and a corresponding lifter 740. When preparing to form a layer of build material in build volume 24, controller 778 outputs control signals causing drive 238 to push or pull chain-link conveyor 530-1 so as to convey build material from build volume 525 and discharge build material into the supply passage 780. The pockets 239 of the chain-link conveyor 640-2 may continually discharge build material at a first portion of a line upon top of ram 772 until the discharged build material at the first portion forms a floor underlying a corresponding first portion of the elongate discharge opening. Thereafter, the pockets of the chain-link conveyor may convey additional build material over the floor formed by the discharged build material at the first portion, wherein the pockets of the chain-link then discharge build material at a second consecutive portion of the line until the discharge build material at the second portion builds up to form a second floor underlying a corresponding second portion of the elongate discharge opening. This process repeats until a line or row of build material, corresponding to the path and length of the elongate discharge opening has been formed on top of ram 772 along the length of supply passage 780 along an axis 783.

In such an implementation, the vertical spacing between the bottom edge of the links and the top of ram 772 below the links (and the chain-link conveyor) control the height of the thus formed row of build material. In such an implementation, the width or diameter of the individual links and the width of the supply passage 780 may control the width of row 32. The width and the height of row 32 control the volume of build material per given unit length of row 32. By controlling the width of the links, the width of the discharge opening and the spacing between the lower edge of the links and the underlying surface, the volume of billed material 33 along row 32 may be controlled so as to provide sufficient build material for forming the build material layer yet reduce excessive amounts of build material that do not form the build material layer.

Controller 778 determines when the row of build material along lift passage 782 has been completed. In one implementation, controller 778 determines that the row 32 has been completed based upon the lapse of time in the given rate at which build material is conveyed by conveyor 530-1. In another implementation, controller 778 may receive signals from a level sensor 788 (schematically illustrated) located at an end of lift chamber 782. For example, in one implementation, sensor 788 may comprise a photo emitter-detector at an end portion of the chamber 782 that senses when the height of the mound forming the end of row 32 blocks the emitter-detector.

In yet another implementation, controller 778 may not determine when the row of build material along the lift passage 782 has been completed. In such an implementation, the chain-link conveyor may be driven at a constant speed. When the row 32 has been completed such that passage 782 sufficiently full, the powder automatically stops discharging (since there is nowhere for the powder to fall into) and it is just carried back down to the supply area. Once in the supply area, the pocket cannot pick up any new powder, and continues back up to the discharge area again and again until there is room to discharge. Depending on the drive mechanism, however, some powder still in the pocket may be displaced (for example, by a sprocket tooth). This is not an issue as the gap will be filled.

Once the row 32 of build material 33 has been formed along the length of the lift chamber 782, controller 778 outputs control signals causing actuator 774 to lift ram 772 to the position shown in FIG. 19B, lifting and elevating the row 32 of build material 33, as a row, to a height at or above the top of build volume 24. While ram 772 is retained at this height, controller 778 outputs control signals to an actuator that drives spreader 50 across the top of ram 772 in the direction indicated by arrow 791 and across the top of build volume 24 so as to spread the row 32 of build material 33 across the top of build volume 24, forming a new layer of build material. Any excess build material not used to form the new layer may be pushed by spreader 50 into passage 782 of the opposite lifter, wherein the excess build material assists in forming the row of build material on the opposite side of the build volume 24. Once the build material has been pushed off of ram 772, ram 772 may be lowered for receiving new row of build material from chain-link conveyor 530-1. This process may be repeated to form another layer of build material.

In the example illustrated, chain-link conveyor 530-1 has an elongate discharge opening so as to form a row 32 of build material 33. The bottom surfaces of the links of conveyor 30 are spaced from an underlying surface (the top surface of ram 772, when lowered) by a distance corresponding to the height of row 32 and therefore the volume of build material for a given length of row 32. The row 32 of build material 33 may extend along an axis 783 parallel to the width W of build volume 24. In some implementations, the row 32 of build material 33 may extend nonparallel to the width W of build container 24 or may extend along a curved or serpentine path.

The row 32 of build material 33 may have a length that extends across at least a majority of the width W of build volume 24. Chain-link conveyor 530-2 has an elongate discharge opening that is to form a row 32 of build material 33 having a length along axis 35 that is within 80% of the width W of build volume 24. In yet another implementation, the discharge opening of chain-link conveyor 530-2 is to form a row 32 of build material 33 having a length equal to the width W of build volume 24. Because chain-link conveyor 530-2 forms a row 32 of build material 33 extending along the edge of build volume 24 in a direction along the width W of build container 24, build chamber 720 may omit or may reduce the use of components such as vibrators, graders or compactors to distribute build material along the width W of build container 24. As a result, build chamber 24 may achieve a more consistent row height, may be more compact and may less costly. By reducing or avoiding reliance upon vibrators to spread material, the likelihood of the build material powder separating or segregating based upon varying powder particle sizes and weights is further reduced. Similar operations may be carried out by chain-link conveyor 530-1 and the lifter 740 on the opposite side of build volume 24.

Although the present disclosure has been described with reference to example implementations, workers skilled in the art will recognize that changes may be made in form and detail without departing from disclosure. For example, although different example implementations may have been described as including features providing various benefits, it is contemplated that the described features may be interchanged with one another or alternatively be combined with one another in the described example implementations or in other alternative implementations. Because the technology of the present disclosure is relatively complex, not all changes in the technology are foreseeable. The present disclosure described with reference to the example implementations and set forth in the following claims is manifestly intended to be as broad as possible. For example, unless specifically otherwise noted, the claims reciting a single particular element also encompass a plurality of such particular elements. The terms “first”, “second”, “third” and so on in the claims merely distinguish different elements and, unless otherwise stated, are not to be specifically associated with a particular order or particular numbering of elements in the disclosure.

What is claimed is:

1. A three-dimensional (3D) printing system build chamber comprising:
a build volume having an underlying build platform;
a chain link conveyor to deposit build material in a row; and
a spreader to spread the row over the build platform.

2. The 3D printing system of claim 1 further comprising a lifter to raise the row as a row to proximate a top of the build volume for spreading by the spreader.

3. The 3D printing system build chamber of claim 2, wherein the lifter extends along a first side of the build volume, the 3D printing system build chamber further comprising:
a second lifter along a second side of the build volume to lift a second row of build material to the top, wherein the spreader is to spread the second row of build material over the build platform.

4. The 3D printing system build chamber of claim 3, wherein the chain link conveyor is to form the second row of build material.

5. The 3D printing system build chamber of claim 3 further comprising a second chain link conveyor to form the second row of build material.

6. The 3D printing system build chamber of claim 5 further comprising a build material supply comprising a double-sided ramp floor having first ramped floor portion declining towards a first side of the material supply and a second ramped floor portion declining towards a second side of the material supply opposite the first side, wherein the chain link conveyor has a first inlet extending across the build material supply along the first side of the build material supply and wherein the second chain link conveyor has a second inlet extending across the build material supply along the second side of the build material supply.

7. The 3D printing system build chamber of claim 1 further comprising a build material supply having an interior to contain build material, wherein the chain link conveyor has an inlet extending across majority of the interior of the build material supply.

8. The 3D printing system build chamber of claim 1 further comprising a build material supply comprising a floor, wherein the chain link conveyor extends along the floor along a serpentine path.

9. The 3D printing system build chamber of claim 8, wherein the floor comprises a double-sided ramp between consecutive legs of the serpentine path, wherein a first side of the double-sided ramp declines towards a first one of the consecutive legs and a second side of the double-sided ramp declines towards a second one of the consecutive legs.

10. The 3D printing system build chamber of claim 1, wherein the lifter is selected from a group of lifters consisting of a rotatable vane and a movable ram.

11. The 3D printing system build chamber of claim 1 comprising a surface underlying and spaced from a discharge opening of the chain link conveyor by distance corresponding to a height of the row of build material.

12. A method comprising:
conveying and depositing a row of build with a chain link conveyor; and
spreading the row of build material over a build platform.

13. The method of claim 12 further comprising supplying the chain link conveyor with the build material from an interior of a build material supply, the chain link conveyor comprising chained links exposed to the interior across a majority of an interior of the build material supply.

14. A three-dimensional (3D) printing system build chamber comprising:
a build volume having an underlying build platform;
a build volume supply having a length; and
a chain link conveyor having chained links exposed to receive build material across a majority of the length of the build volume supply, the chain link conveyor extending along a vertical path to vertically lift build material; and
a spreader to spread the build material lifted by the chain link conveyor across the platform.

15. The 3D printing system build chamber of claim 14 further comprising a lifter to receive a row of build material conveyed by the chain link conveyor and movable to raise the row of build material to above the top of the build volume, wherein the spreader is to spread the build material on top of the lifter across the build volume over the platform.
